(19) United States
(12) Patent Application Publication
(10) Pub. No.: US 2025/0266571 A1
(43) Pub. Date: Aug. 21, 2025

(54) Oxidized Porous Films

(71) Applicant: Celanese International Corporation, Irving, TX (US)

(72) Inventors: David Ditter, Sulzbach Am Taunus (DE); Christian Ohm, Sulzbach Am Taunus (DE); Fangfang Tao, Shanghai (CN); Rainier Walkenhorst, Sulzbach Am Taunus (DE); Yingying Sun, Shanghai (CN)

(21) Appl. No.: 18/857,254

(22) PCT Filed: Apr. 25, 2022
(86) PCT No.: PCT/CN2022/089024

§ 371 Date: Oct. 16, 2024

(51) Int. Cl. H01M 50/417; H01M 50/403; H01M 50/449; H01M 50/491; H01M 50/494

(52) U.S. Cl. CPC H01M 50/417; H01M 50/403; H01M 50/449; H01M 50/491; H01M 50/494

(57) ABSTRACT

Porous polymer films and fibers are disclosed that are subjected to an oxygen plasma treatment without causing a deterioration of mechanical properties. In one aspect, the plasma process can be a low pressure plasma process with microwave discharge. Exposure times can be minimized for preserving physical properties. Porous polymer films made according to the present disclosure can show dramatically improved wicking properties when tested against electrolyte solutions, indicating a significant increase in ion conductivity.

### BACKGROUND

Polyethylene polymers have numerous and diverse uses and applications. For example, high density polyethylenes are valuable engineering plastics, with a unique combination of abrasion resistance, surface lubricity, chemical resistance and impact strength. They find application in the production of high strength fibers for use in ropes and anti-ballistic shaped articles and in the production of other elongated articles, such as membranes for electronic devices. However, since the flowability of these materials in the molten state decreases as the molecular weight increases, processing by conventional techniques, such as melt extrusion, is not always possible.

One alternative method for producing fibers and other elongated components from polyethylene polymers is by gel-processing in which the polymer is combined with a solvent. The resultant gel is extruded into a fiber or membrane and may be stretched in one or two directions. After the article is formed, all of the solvent may be removed from the product.

Films made from polyethylene polymers through gel-processing can be formed to have many beneficial properties. For instance, the films can be formed with micro-pores. Microporous polyethylene films formed through gel-processing, for instance, are particularly well suited for use as a separator in a battery, such as a lithium ion battery. The microporous film, for instance, can separate an anode from a cathode and prevent a short circuit between the active battery components. At the same time, the microporous film permits ions to pass through due to the porous nature of the material. The ion permeability characteristics of the microporous polyethylene film makes the material particularly well suited for regulating electrochemical reactions within the battery.

In view of the above, one of the important characteristics of lithium ion battery films is the compatibility between the membrane and the electrolyte solution. In this regard, the present disclosure is directed to an improved method for increasing the wicking or soaking compatibility characteristics of films that can be incorporated into lithium ion batteries. The present disclosure is also directed to porous polymer films that display improved ion conductivity when positioned between an anode and a cathode of an electronic device, such as a lithium ion battery.

### SUMMARY

In general, the present disclosure is directed to porous polymer films that are well suited for use in electronic devices. The porous polymer films can be used as ion permeable membranes positioned between an anode and a cathode. The porous polymer film is generally formed from one or more high density polyethylene polymers that also have a high molecular weight. In accordance with the present disclosure, at least one surface of the porous polymer film is subjected to an oxygen plasma treatment that dramatically improves the ion conductivity of the film that can be shown through a soaking test. The oxygen plasma treatment of the present disclosure is particularly configured to significantly improve ion conductivity without causing significant decreases in mechanical properties.

In one embodiment, the present disclosure is directed to an ion separator for dividing an anode from a cathode. The ion separator comprises a porous polymer film made from a high density polyethylene polymer. The polyethylene polymer can have a number average molecular weight of greater than about 300,000 g/mol, such as greater than about 400,000 g/mol, such as greater than about 500,000 g/mol, and generally less than about 12,000,000 g/mol, such as less than about 6,000,000 g/mol, such as less than about 2,000,000 g/mol, such as less than about 1,200,000 g/mol, such as less than about 800,000 g/mol. The porous polymer film has a first surface and a second and opposite surface. In accordance with the present disclosure, at least the first surface of the porous polymer film has been plasma oxidized to form polar groups attached to the high density polyethylene polymer. The polar groups increase the polarity of the surface of the porous polymer film. The plasma oxidized polar groups are present on the first surface of the film in an amount sufficient to increase a wicking distance of the porous polymer film when subjected to a soaking test and tested against propylene carbonate of greater than about 50%, such as greater than about 60%, such as greater than about 70%, such as greater than about 80%, such as greater than about 90%, such as even greater than about 100% in comparison to an identical porous polymer film that has not been plasma oxidized.

In one embodiment, both the first surface and the second surface of the porous polymer film can be plasma oxidized to form the polar groups attached to the high density polyethylene polymer.

In one aspect, a low pressure plasma process is used with microwave discharge. The pressure in the plasma chamber, for instance, during plasma treatment can be less than about 10,000 pa, such as less than about 5,000 pa, such as less than about 500 pa, such as less than about 200 pa, such as less than about 150 pa, such as less than about 100 pa, such as less than about 30 pa. The temperature can also be relatively low during plasma treatment. For instance, the oxygen plasma process can be carried out at a temperature of less than about 60° C., such as less than about 40° C., such as less than about 35° C. It was discovered that only exposing the porous polymer film to oxygen plasma for a relatively short amount of time using the low pressure, microwave plasma process can result in a significant and uniform increase in ion conductivity without deteriorating the mechanical properties of the film. In this regard, the first surface of the porous film can be subjected to the oxygen plasma for an amount of time of less than about 60 seconds, such as less than about 30 seconds, such as less than about 20 seconds, such as less than about 15 seconds, such as less than about 10 seconds.

During the plasma process, the porous polymer film may shrink by no more than about 5%, such as by no more than about 3%, such as by no more than about 1% in one direction. In addition, the porous polymer film can be plasma oxidized without causing the film to decrease in tensile strength in one direction by more than about 10%, such as by more than about 8%, such as by more than about 5%. The plasma oxidized porous polymer film, for example, can have a tensile strength in some embodiments of greater than about 70 MPa, such as greater than about 100 MPa, such as greater than about 120 MPa, such as greater than about 155 MPa, such as greater than about 160 MPa, such as greater than about 162 MPa, such as greater than about 164 MPa, such as greater than about 166 MPa, such as greater than about 168 MPa, such as greater than about 170 MPa, and generally less than about 250 MPa. At a porosity of from about 35% to about 38%, the porous polymer film can have a puncture strength of greater than about 1000 mN/micron, such as greater than about 1200 mN/micron, such as greater than about 1450 mN/micron and a pin strength of greater than about 175 gf/g/cm², such as greater than about 200 gf/g/cm², such as greater than about 225 gf/g/cm², such as greater than about 250 gf/g/cm². At a porosity of about 38% to about 50%, the porous polymer film can have a puncture strength of greater than about 340 mN/micron and a pin strength of greater than about 70 gf/g/cm².

The porous polymer film can also have a relatively low contact angle when tested against water. For instance, the oxidized plasma treatment can reduce the contact angle of the porous polymer film when measured against water of greater than about 15%, such as greater than about 25%, such as greater than about 35%, such as greater than about 45% in comparison to an identical porous polymer film that has not been plasma oxidized. The porous polymer film, for example, can display a contact angle when measured against water of less than about 90°, such as less than about 80°, such as less than about 70°.

The porous polymer film can be made primarily from one or more high density polyethylene polymers. One or more high density polyethylene polymers, for instance, may be contained in the film in an amount from about 60% by weight to about 99.5% by weight, such as from about 80% by weight to about 98% by weight. In one embodiment, the porous polymer film is made from a single high density polyethylene polymer and does not contain any polypropylene polymers. The polyethylene polymer can be a Ziegler-Natta catalyzed high molecular weight polyethylene polymer. The porous polymer film can also be a single layer porous polymer film that may optionally include a coating. Coatings that may be applied to the film include inorganic coatings and/or polymer coatings. The porous polymer film can be biaxially stretched.

### BRIEF DESCRIPTION OF THE DRAWINGS

The present disclosure may be better understood with reference to the following figure:

FIG. 1 is one embodiment of an oxygen plasma process that may be used to treat porous polymer films in accordance with the present disclosure; and

FIG. 2 is a cross-sectional view of an electronic device, such as a battery, incorporating a porous membrane or film made in accordance with the present disclosure.

Repeat use of reference characters in the present specification and drawings is intended to represent the same or analogous features or elements of the present invention.

### Definitions

The melt flow rate of a polymer or polymer composition is measured according to ISO Test 1133 at 190° C. and at a load of 21.6 kg.

The density of a polymer is measured according to ISO Test 1183 in units of g/cm³.

Average particle size (d50) is measured using laser diffraction/light scattering, such as a suitable Horiba light scattering device.

The average molecular weight of a polymer is determined using the Margolies' equation.

Tensile modulus, tensile stress at yield, tensile strain at yield, tensile stress at 50% break, tensile stress at break, and tensile nominal strain at break are all measured according to ISO Test 527-2/1B.

The full width at half maximum of a melting endothermic peak of a sample is measured with a differential scanning calorimeter (DSC). An electronic balance is used to measure 8.4 g of a sample. The sample is placed in an aluminum sample pan. An aluminum cover is attached to the pan, which is set in the differential scanning calorimeter. The sample and a reference sample are retained at 40° C. for one minute while nitrogen purge is performed at a flow rate of 20 mL/min then heated from 40° C. to 180° C. at a heating rate of 10° C./min, retained at 180° C. for 5 minutes, and then cooled to 40° C. at a cooling rate of 10° C./min. A baseline is drawn from 60° C. to 150° C. in the melting curve acquired during the process and the full width at half maximum of a melting endothermic peak is derived using analysis software, such as “Pyris Software (Version 7).” The test can be conducted using a DSC Q2000 calorimeter available from TA Instruments.

The half-crystallization period of time during an isothermal crystallization at 123° C. can be determined from the time that requires a quantity of heat measured during an isothermal crystallization measurement at 123° C. to correspond to the half of the peak area in differential scanning calorimetry (DSC) measurement. The test can be conducted using a DSC Q2000 calorimeter available from TA Instruments.

Contact angle measurements are performed on a Krüss DSA 100 instrument. A membrane sample (10×40 mm) is attached to a microscope slide using double sided adhesive tape. Static charging is dissipated by moving the prepared sample several times through a U-electrode static discharger. The sample is mounted in a measurement device and a 3.5 μl droplet of testing fluid (water or ethyleneglycol) is placed on the membrane. The contact angle is determined through the software for 7 seconds (one measurement per second) after placement of the droplet. These 7 data points are averaged to yield the contact angle at the point of measurement. Every sample is measured at 6 different spots or locations on each side and all results are averaged to the reported value.

A soaking test may be used to determine the wicking characteristics of membranes made in accordance with the present disclosure according to the following procedure.

For the soaking test a glass vessel is used with following dimensions: 20×10 cm upper area (covered with a metal plate)/19×8 cm lower area (base)/height: 10 cm). Two filter papers are sticked at the inside of the glass vessel with a tape. 300 ml propylene carbonate is filled into the vessel afterwards (fluid level: 2 cm). The vessel is covered with a metal plate and propylene carbonate is allowed to fill the gas space for 20 minutes.

Membranes are cut with scissors into pieces (length: 70 mm, width: 7 mm). This is done with nitrile gloves to prevent touching the membranes with the bare hand. The pieces are mounted on an anodized metal plate (140 mm×70 mm, frame width: 10 mm, slope: 80°) with the help of magnets. The MD direction of membranes shows upwards (=soaking direction).

The metal frame with the fixed membranes are then moved 40 times through a deionizer to remove electrostatic charges. After that the frame is placed into the vessel filled with propylene carbonate at room temperature and soaking of the membranes with propylene carbonates takes place for a desired time. During soaking takes place the vessel is closed with a metal plate. The different soaking distances of the membranes are measured every 30 minutes by taking a photo and measuring the distance with a suitable computer program.

Soaking distances of tested membranes is compared to draw conclusion on their battery electrolyte affinity.

Gurley permeability can be measured according to the Gurley Test, using a Gurley permeability tester, such as Gurley Densometer, Model KRK 2060c commercially available from Kumagai Riki Kogyo Co., LTD. The test is conducted according to ISO Test 5636. The Gurley Test measures air permeability as a function of the time required for a specified amount of air to pass through a specified area under a specified pressure. The units are reported in see/100 ml.

Porosity (%) is measured according to the following procedure. During the procedure, the following ASTM Standards are used as a reference: D622 Standard Test Method for Apparent Density of Rigid Cellular Plastics1; and D729 Standard Test Methods for Density and Specific Gravity (Relative Density) of Plastics by Displacement1. The following instruments are used: Calibrated Analytical Balance (0.0001 grams); Lorentzen & Wettre Micrometer, code 251 (0.1 um); and Deli 2056 art knife.

### Procedure:

### 1.1. Samples and Sample Preparation

Using the specimen art knife, cut each sample material into a minimum of three 60 mm±0.5 by 60 mm±0.5 specimens

### 1.2. Instrument and Measurement

3.2.1 Using the L&W micrometer, take five readings of the thickness at each 60 mm by 60 mm specimen (average of 5 readings). Record this value as the thickness of this specimen.

3.2.2 Weigh the specimen directly on the balance. Record this value as the weight of this specimen.

3.2.3 The three specimens of the same sample are placed together and steps 3.2.1 and 3.2.2 are repeated to obtain the thickness and the weight.

Calculate the density to three significant figures as follows

$$a . Dfilm = Density ( film ) = \frac{Wt . of Specimen}{THK * Square}$$

$$Dfilm = density of specimen , ( mg / mm 3 )$$

$$Wt = weight of specimen , ( mg )$$

$$THK = thickness of specimen , ( mm )$$

$$Square = area of specimen , ( mm 2 )$$

$$b . Dpolymer = Density ( polymer ) 0.96 ( g / cm 3 )$$

$$Dpolymer : Density of raw materials , without the pores .$$

$$c . Porosity = ( 1 - Dfilm / Dpolymer ) * 100 \%$$

As used herein, puncture strength is measured according to ASTM Test D3763 and measures the ability of a membrane to withstand a foreign particle from causing a hole or defect. The test is conducted on a testing device, such as an Instron CEAST 9340 device. The drop height is 0.03 to 1.10 m. The impact velocity is 0.77 to 4.65 m/s. The maximum dropping mass is 37.5 kg and the maximum potential energy is 405 J. Puncture strength is measured in slow speed puncture mode at 1.67 mm/s. Puncture strength can be normalized by dividing by the thickness of the membrane resulting in units of mN/micron.

Heat shrinkage of a membrane is determined by putting a piece of membrane (3 in ×3 in) in an oven at 105° C. for 1 h. Shrinkage is calculated by measuring the size in MD and TD direction before and after heat treatment.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to porous polymer films made from a high density polyethylene polymer that have been subjected to an oxygen plasma treatment on at least one surface of the film. The porous polymer film is particularly well suited for use as an ion separator in an electronic device, such as a lithium ion battery. These battery cells are filled with an electrolyte solution. The electrolyte solution typically contains an alkylene carbonate, such as propylene carbonate, in combination with a lithium compound, such as lithium hexafluorophosphate. The lithium compound is dissolved in the electrolyte solution. Although porous polymer films made from high density polyethylene polymers have excellent mechanical and porous properties, the films do not have a high affinity for the polar electrolyte. This incompatibility leads to a time consuming battery production process where the porous polymer film made from the polyethylene polymer needs to be soaked with the polar electrolyte. Incomplete electrolyte filling and poor compatibility between the porous polymer film and the electrolyte can lead to reduced performance of the battery, reduced lifetime, high internal resistance, and reduced energy density. In this regard, the porous polymer film of the present disclosure is subjected to an oxygen plasma treatment on at least one side that greatly increases the affinity of the surface of the film to the polar electrolyte.

In the past, those skilled in the art have suggested modifying the surface of a polymer membrane to increase hydrophilicity through a plasma process. As stated in Korean Patent No. 100349606 (which is incorporated herein by reference), problems have been experienced in using plasma to surface treat membranes. For instance, KR '606 states that it is difficult to control uniformity due to the unique characteristics of the plasma itself. Also, the plasma is accompanied by various unwanted side reactions. In addition, plasma treatments have been found to physically damage the membranes. As stated in KR '606, as a result, mechanical properties are reduced making it difficult to manufacture a separator having a high level of physical properties.

The present disclosure, however, is directed to oxygen plasma treatments that not only greatly improve the compatibility of the porous polymer film with the electrolyte solution and increase ion conductivity but do so without adversely impacting the mechanical properties of the film.

For example, in one aspect, the plasma process of the present disclosure is conducted using microwave discharge. In addition, the process can be carried out at very low pressures and at extremely short contact times so as to preserve the physical properties of the porous polymer film.

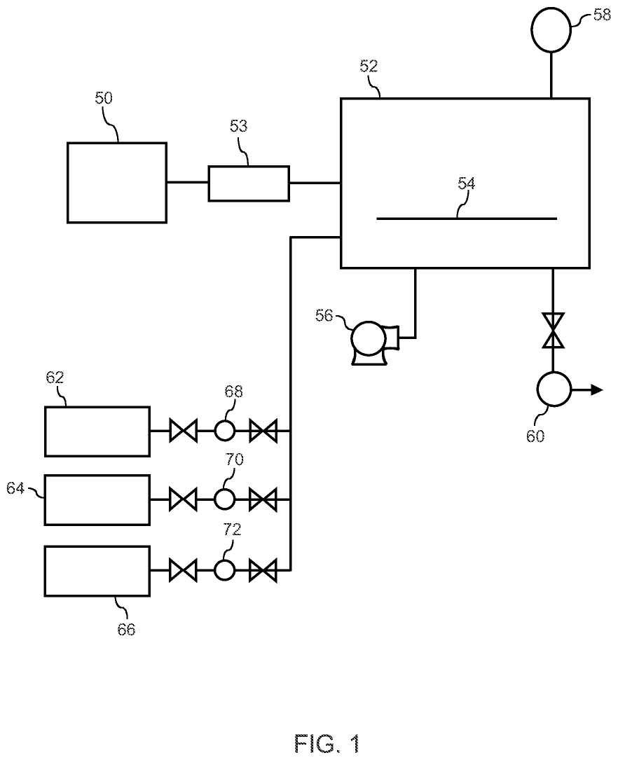

One embodiment of a plasma process that may be used in accordance with the present disclosure is shown in FIG. 1. Referring to FIG. 1, the plasma process includes a microwave supply 50 that is in communication with a vacuum chamber 52 via a resonant cavity 53. The resonant cavity 53 can include or be associated with an impedance matching system. A substrate holder 54 is contained within the vacuum chamber 52. The vacuum chamber 52 is also associated with a pressure monitoring device 58.

In order to evacuate the chamber 52, the chamber 52 can be placed in communication with a pump 56. The vacuum chamber 52 is also in communication with an exhaust 60.

As shown in FIG. 1, the vacuum chamber 52 can also be placed in fluid communication with one or more gas supplies. In the embodiment illustrated in FIG. 1, three different gas supplies are shown 62, 64, and 66. Each gas supply 62, 64, and 66 is placed in association with a corresponding mass flow rate controller 68, 70, and 72. The gas supplies 62, 64, and 66 are for feeding oxygen alone or in combination with other gases to the vacuum chamber 52.

As described above, in one embodiment, a microwave plasma reactor is used to deliver an oxygen plasma to the porous polymer films. Although other plasma reactors may be used in accordance with the present disclosure, in one embodiment, a low pressure plasma system with microwave discharge is preferred. In the past, for instance, inductively coupled plasma systems were typically used that contain an RF generator. The two reactors, however, differ in many different respects, including the conditions produced and the processes applied. When using microwave reactors, for instance, the porous polymer film samples can be placed outside of the active plasma zone, while in inductively coupled plasma reactors, the samples can be subjected to a significant amount of ion bombardment. Thus, the fluxes of charged particles that reach the sample can differ enormously between the two processes. In addition, it is believed that inductively coupled plasma reactors can cause the substrate to heat up much faster than when used in plasma reactors.

During oxygen plasma treatment, a porous polymer film sample is placed into the vacuum chamber 52 and the chamber is evacuated using the pump 56. A plasma is then fed to the vacuum chamber 52 produced by the microwave supply 50 in conjunction with one or more gases that contain oxygen. Sources of oxygen can vary depending upon the particular application. In one embodiment, pure oxygen gas is fed to the vacuum chamber 52. In alternative embodiments, however, oxygen can be combined with other gases, such as inert gases. For instance, oxygen can be combined with nitrogen. In one embodiment, air is fed to the plasma chamber 52. Other sources of oxygen include hydrogen peroxide, water (steam), nitrous oxide, ozone, and the like. In one embodiment, the gas that is fed to the plasma chamber 52 contains greater than about 20% oxygen, such as greater than about 30% oxygen, such as greater than about 50% oxygen by volume.

During oxygen plasma treatment, an ionized gas is formed that contains various different positive and negative ions and optionally free radicals, photons, and neutral species. The ionized gas initiates reactions on the surface of the porous polymer film that ultimately modify the chemical properties of the surface. For instance, the polyethylene polymer can be oxidized in the presence of oxygen. The plasma oxidized surface, for instance, can contain various different polar groups that increase the polarity of the surface of the porous polymer film.

The conditions within the plasma chamber 52 during the plasma process can vary. In one embodiment, the oxygen plasma process is carried out at low pressures. For instance, the pressure within the chamber can be maintained below one atmosphere. For instance, the pressure within the chamber can be below about 10,000 pa, such as less than about 5,000 pa, such as less than about 1,000 pa, such as less than about 500 pa, such as less than about 300 pa, such as less than about 200 pa. In one embodiment, the process is carried out at very low pressures such as less than about 150 pa, such as less than about 130 pa, such as less than about 100 pa, such as less than about 80 pa, such as less than about 50 pa, such as less than about 30 pa. The temperature during the process can generally be less than about 60° C., such as less than about 50° C., such as less than about 40° C., such as less than about 30° C., such as less than about 28° C., such as less than about 25° C., and generally greater than about 15° C., such as greater than about 20° C.

In accordance with the present disclosure, the contact time between the porous polymer film and the oxygen plasma, in one embodiment, can be relatively short. For example, in one embodiment, each side of the porous polymer film can be exposed to the plasma for times of less than about 30 seconds, such as less than about 25 seconds, such as less than about 20 seconds, such as less than about 15 seconds, such as less than about 12 seconds, such as less than about 10 seconds, such as less than about 8 seconds, such as less than about 6 seconds. Contact times are generally greater than about 1 second, such as greater than about 2 seconds, such as greater than about 3 seconds. It was discovered that very short contact times provide the necessary ion conductivity without adversely impacting the physical properties of the film, especially when using microwave generated plasma at low pressures.

Porous polymer films made according to the present disclosure possess excellent ion conductivity characteristics in combination with excellent physical properties. The ion conductivity characteristics, for instance, can be exemplified by testing the affinity of the film to an electrolyte solution in a soaking test, which determines the ability of the film to wick electrolyte fluids. For example, when subjected to a soaking test in propylene carbonate, the oxygen plasma treatment of the present disclosure can increase the wicking distance by greater than about 50%, such as by greater than about 60%, such as by greater than about 70%, such as by greater than about 80%, such as by greater than about 90%, such as by greater than about 100%, in comparison to an identical porous polymer film that has not been plasma oxidized. The soaking distance of membranes can vary depending upon many factors, such as the porosity of the membrane and the pore size.

The porous polymer film can also have enhanced wettability properties. For example, the plasma oxidized film of the present disclosure can reduce a contact angle of the film when measured against water in an amount greater than about 15%, such as in an amount greater than about 25%, such as in an amount greater than about 35%, such as in an amount greater than about 45%, in comparison to an identical porous polymer film that has not been plasma oxidized. The porous polymer film subjected to the oxygen plasma process, for instance, can display a contact angle when measured against water of less than about 90°, such as less than about 80°, such as less than about 70°, and generally greater than about 20°.

In one aspect, the above properties are obtained without substantially deteriorating the mechanical properties of the plasma oxidized porous polymer film. For instance, the oxygen plasma process can decrease the tensile strength of the film in one direction by no more than about 10%, such as by no more than about 8%, such as by no more than about 5%. In addition, the process can be controlled to prevent shrinkage of the film. For example, the porous polymer film can be plasma oxidized without causing the film to shrink more than about 5%, such as by more than about 3%, such as by more than about 1% in one direction.

Porous membranes or films made according to the present disclosure can generally have a thickness of greater than about 5 microns, such as greater than about 6 microns, such as greater than about 7 microns, such as greater than about 8 microns, such as greater than about 9 microns, such as greater than about 10 microns, such as greater than about 11 microns. The thickness of the membranes or films is generally less than about 20 microns, such as less than about 16 microns, such as less than about 14 microns, such as less than about 12 microns, such as less than about 10 microns, such as less than about 8 microns.

Membranes or films made according to the present disclosure can have excellent physical properties. For example, membranes or films having a porosity of from about 35% to about 38% can have a puncture strength of greater than about 1,000 mN/micron, such as greater than about 1,200 mN/micron, such as greater than about 1,400 mN/micron, such as greater than about 1,475 mN/micron, such as greater than about 1,500 mN/micron, such as greater than about 1,525 mN/micron, such as greater than about 1,550 mN/micron, such as greater than about 1,575 mN/micron, such as greater than about 1,600 mN/micron, such as greater than about 1,625 mN/micron, such as greater than about 1,650 mN/micron, and generally less than about 3,000 mN/micron. The pin strength can be greater than about 200 gf/g/cm², such as greater than about 250 gf/g/cm², such as greater than about 252 gf/g/cm², such as greater than about 254 gf/g/cm², such as greater than about 256 gf/g/cm², such as greater than about 258 gf/g/cm², such as greater than about 260 gf/g/cm², such as greater than about 262 gf/g/cm², and generally less than about 300 gf/g/cm².

At a membrane or film porosity of from about 45% to about 50%, the membrane or film can have a puncture strength of greater than about 300 mN/micron, such as greater than about 340 mN/micron, such as greater than about 350 mN/micron, such as greater than about 360 mN/micron, such as greater than about 370 mN/micron, such as greater than about 380 mN/micron, such as greater than about 390 mN/micron, such as greater than about 400 mN/micron, and generally less than about 600 mN/micron and can have a pin strength of greater than about 60 gf/g/cm², such as greater than about 65 gf/g/cm², such as greater than about 72 gf/g/cm², such as greater than about 74 gf/g/cm², such as greater than about 76 gf/g/cm², such as greater than about 78 gf/g/cm², such as greater than about 80 gf/g/cm², such as greater than about 82 gf/g/cm², and generally less than about 150 gf/g/cm².

Membranes or films made according to the present disclosure can also have excellent tensile strength properties in either the machine direction or the cross-machine direction. For instance, in either direction, the membrane or film can have a tensile strength of greater than about 100 MPa, such as greater than about 125 MPa, such as greater than about 140 MPa, such as greater than about 150 MPa, such as greater than about 160 MPa, such as greater than about 162 MPa, such as greater than about 164 MPa, such as greater than about 166 MPa, such as greater than about 168 MPa, such as greater than about 170 MPa, and generally less than about 250 MPa.

Polymer membranes or films made according to the present disclosure can have a Gurley permeability of greater than about 105 sec/100 ml, such as greater than about 150 sec/100 ml, such as greater than about 200 sec/100 ml, such as greater than about 225 sec/100 ml, such as greater than about 250 sec/100 ml, such as greater than about 275 sec/100 ml, such as greater than about 300 sec/100 ml, such as greater than about 325 sec/100 ml, such as greater than about 350 sec/100 ml, such as greater than about 375 sec/100 ml, such as greater than about 400 sec/100 ml, such as greater than about 425 sec/100 ml, such as greater than about 450 sec/100 ml, such as greater than about 475 sec/100 ml, such as greater than about 500 sec/100 ml, such as greater than about 525 sec/100 ml, such as greater than about 550 sec/100 ml, such as greater than about 575 sec/100 ml, such as greater than about 600 sec/100 ml, and generally less than about 1,000 sec/100 ml.

As described above, porous polymer films made according to the present disclosure are formed from one or more high density polyethylene polymers. The high density polyethylene has a density of about 0.93 g/cm³ or greater, such as about 0.94 g/cm³ or greater, such as about 0.95 g/cm³ or greater, and generally less than about 1 g/cm³, such as less than about 0.96 g/cm³.

The high density polyethylene polymer can be made from over 90% ethylene derived units, such as greater than 95% ethylene derived units, or from 100% ethylene derived units. The polyethylene can be a homopolymer or a copolymer, including a terpolymer, having other monomeric units.

The high density polyethylene can be a high molecular weight polyethylene, a very high molecular weight polyethylene, and/or an ultrahigh molecular weight polyethylene. “High molecular weight polyethylene” refers to polyethylene compositions with an average molecular weight of at least about 3×10⁵ g/mol and, as used herein, is intended to include very-high molecular weight polyethylene and ultra-high molecular weight polyethylene. For purposes of the present specification, the molecular weights referenced herein are determined in accordance with the Margolies equation (“Margolies molecular weight”).

“Very-high molecular weight polyethylene” refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” refers to polyethylene compositions with an average molecular weight of at least about 3×10⁶ g/mol. In some embodiments, the molecular weight of the ultra-high molecular weight polyethylene composition is between about 3×10⁶ g/mol and about 30×10⁶ g/mol, or between about 3×10⁶ g/mol and about 20×10⁶ g/mol, or between about 3×10⁶ g/mol and about 10×10⁶ g/mol, or between about 3×10⁶ g/mol and about 6×10⁶ g/mol.

In one aspect, the high density polyethylene is a homopolymer of ethylene. In another embodiment, the high density polyethylene may be a copolymer. For instance, the high density polyethylene may be a copolymer of ethylene and another olefin containing from 3 to 16 carbon atoms, such as from 3 to 10 carbon atoms, such as from 3 to 8 carbon atoms. These other olefins include, but are not limited to, propylene, 1-butene, 1-pentene, 1-hexene, 1-heptene, 1-octene, 4-methylpent-1-ene, 1-decene, 1-dodecene, 1-hexadecene and the like. Also utilizable herein are polyene comonomers such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene. However, when present, the amount of the non-ethylene monomer(s) in the copolymer may be less than about 10 mol. %, such as less than about 5 mol. %, such as less than about 2.5 mol. %, such as less than about 1 mol. %, wherein the mol. % is based on the total moles of monomer in the polymer.

In one embodiment, the high density polyethylene may have a monomodal molecular weight distribution. Alternatively, the high density polyethylene may exhibit a bimodal molecular weight distribution. For instance, a bimodal distribution generally refers to a polymer having a distinct higher molecular weight and a distinct lower molecular weight (e.g. two distinct peaks) on a size exclusion chromatography or gel permeation chromatography curve. In another embodiment, the high density polyethylene may exhibit more than two molecular weight distribution peaks such that the polyethylene exhibits a multimodal (e.g., trimodal, tetramodal, etc.) distribution. Alternatively, the high density polyethylene may exhibit a broad molecular weight distribution wherein the polyethylene is comprised of a blend of higher and lower molecular weight components such that the size exclusion chromatography or gel permeation chromatography curve does not exhibit at least two distinct peaks but instead exhibits one distinct peak broader than the individual component peaks.

Any method known in the art can be utilized to synthesize the polyethylene. The polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene is usually polymerized in gaseous phase or slurry phase at relatively low temperatures and pressures. The polymerization reaction may be carried out at a temperature of between 50° C. and 100° C. and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid fouling and product contamination.

Suitable catalyst systems include but are not limited to Ziegler-Natta type catalysts. Typically, Ziegler-Natta type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system can be obtained by the reaction of a titanium(IV) compound with a trialkyl aluminum compound in an inert organic solvent at temperatures in the range of −40° C. to 100° C., preferably −20° C. to 50° C. The concentrations of the starting materials are in the range of 0.1 to 9 mol/L, preferably 0.2 to 5 mol/L, for the titanium(IV) compound and in the range of 0.01 to 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40° C. to 200° C., preferably −20° C. to 150° C. In the first step the titanium(IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium(IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50⁰ to 100° C. In a second reaction stage the reaction mixture formed is subjected to heat treatment for a period of about 10 to 100 hours at a temperature of 110⁰ to 200° C. accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium, magnesium and zinc stearate.

Optionally, other catalysts such as Phillips catalysts, metallocenes and post metallocenes may be employed. Generally, a cocatalyst such as alumoxane or alkyl aluminum or alkyl magnesium compound is also employed. Other suitable catalyst systems include Group 4 metal complexes of phenolate ether ligands.

Polyethylene polymers particularly well suited for use in the present disclosure have a full width at half maximum of a melting endothermic peak when measured with a differential scanning calorimeter of greater than about 6 degrees C., such as greater than about 6.2 degrees C., such as greater than about 6.4 degrees C., such as greater than about 6.5 degrees C., such as greater than about 6.8 degrees C., and generally less than about 9 degrees C. The polyethylene polymer can also have a half-crystallization time period during an isothermal crystallization at 123° C. of greater than about 2 minutes, such as greater than about 2.5 minutes, such as greater than about 3.0 minutes, such as greater than about 3.5 minutes, such as greater than about 4.0 minutes, such as greater than about 4.5 minutes, and generally less than about 12 minutes.

In accordance with the present disclosure, the high density polyethylene polymer is formed into particles and combined with a plasticizer. In one embodiment, the polyethylene particles are made from a polyethylene polymer having a relatively low bulk density as measured according to DIN53466. For instance, in one embodiment, the bulk density is generally less than about 0.4 g/cm³, such as less than about 0.35 g/cm³, such as less than about 0.33 g/cm³, such as less than about 0.3 g/cm³, such as less than about 0.28 g/cm³, such as less than about 0.26 g/cm³. The bulk density is generally greater than about 0.1 g/cm³, such as greater than about 0.15 g/cm³. In one embodiment, the polymer has a bulk density of from about 0.2 g/cm³ to about 0.27 g/cm³.

In one embodiment, the polyethylene particles can be a free-flowing powder. The particles can have a median particle size (d50) by volume of less than 200 microns. For example, the median particle size (d50) of the polyethylene particles can be less than about 150 microns, such as less than about 125 microns. The median particle size (d50) is generally greater than about 20 microns. The powder particle size can be measured utilizing a laser diffraction method according to ISO 13320.

In one embodiment, 90% of the polyethylene particles can have a particle size of less than about 250 microns. In other embodiments, 90% of the polyethylene particles can have a particle size of less than about 200 microns, such as less than about 170 microns.

The molecular weight of the polyethylene polymer can vary depending upon the particular application. The polyethylene polymer, for instance, may have an average molecular weight, as determined according to the Margolies equation.

The molecular weight can be determined by first measuring the viscosity number according to DIN EN ISO Test 1628. Dry powder flow is measured using a 25 mm nozzle. The molecular weight is then calculated using the Margolies equation from the viscosity numbers. The average molecular weight is generally greater than about 300,000 g/mol, such as greater than about 500,000 g/mol, such as greater than about 650,000 g/mol, such as greater than about 1,000,000 g/mol, such as greater than about 2,000,000 g/mol, such as greater than about 2,500,000 g/mol, such as greater than about 3,000,000 g/mol, such as greater than about 4,000,000 g/mol. The average molecular weight is generally less than about 12,000,000 g/mol, such as less than about 10,000,000 g/mol. In one aspect, the number average molecular weight of the high density polyethylene polymer can be less than about 4,000,000 g/mol, such as less than about 3,000,000 g/mol.

In one aspect, the composition or membrane can include only a single polyethylene polymer. The single polyethylene polymer can have an average molecular weight of 500,000 g/mol or greater, such as greater than about 600,000 g/mol and generally less than 2,500,000 g/mol, such as less than about 1,200,000 g/mol, such as less than about 900,000 g/mol, such as less than about 800,000 g/mol.

The polyethylene may have a viscosity number of from at least 100 mL/g, such as at least 500 mL/g, such as at least 550 mL/g, to less than about 6,000 mL/g, such as less than about 5,000 mL/g, such as less than about 4000 mL/g, such as less than about 3,000 mL/g, such as less than about 1,000 mL/g, as determined according to ISO 1628 part 3 utilizing a concentration in decahydronapthalene of 0.0002 g/mL.

The high density polyethylene may have a crystallinity of from at least about 40% to 85%, such as from 45% to 80%. In one aspect, the crystallinity can be greater than about 50%, such as greater than about 55%, such as greater than about 60%, such as greater than about 65%, such as greater than about 70%, and generally less than about 80%.

When combined with a plasticizer in forming porous films or membranes, the high density polyethylene particles are present in the polymer composition in an amount up to about 50% by weight. For instance, the high density polyethylene particles can be present in the polymer composition in an amount less than about 45% by weight, such as in an amount less than about 40% by weight, such as in an amount less than about 35% by weight, such as in an amount less than about 30% by weight, such as in an amount less than about 25% by weight, such as in an amount less than about 20% by weight, such as in an amount less than about 15% by weight. The polyethylene particles can be present in the composition in an amount greater than about 5% by weight, such as in an amount greater than about 10% by weight, such as in an amount greater than about 15% by weight, such as in an amount greater than about 20% by weight, such as in an amount greater than about 25% by weight.

During gel processing, a plasticizer is combined with the high density polyethylene particles which can be substantially or completely removed in forming polymer articles. For example, in one embodiment, the resulting polymer article can contain the high density polyethylene polymer in an amount greater than about 50% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight, such as in an amount greater than about 99% by weight, such as in an amount greater than about 99.5% by weight.

In one aspect, the porous polymer film can be made exclusively from one or more high density polyethylene polymers. In an alternative embodiment, one or more surface tension reducing agents can be combined with the polyethylene polymer in order to further improve the wettability characteristics of articles made from the composition. Surface tension reducing additives that may be used in accordance with the present disclosure generally comprise any suitable additive that can be melt processed with the high density polyethylene particles and lower the surface tension of articles made from the polymer composition. The surface tension reducing additive, for instance, can be a hydrophilic inorganic filler, hydrophilic organic polymeric particles, a hydrophilic chemical agent that forms functional hydrophilic chemical groups on the polymer, or combinations thereof.

In one aspect, the surface tension reducing agent can comprise a polyolefin polymer particularly a polyethylene polymer functionalized with an organic acid, such as an organic acid anhydride. For example, the polyolefin polymer, such as a polyethylene polymer, can be modified to include hydrophilic carboxyl groups. The carboxyl groups can be added to the polymer by oxidation, by polymerization, or by grafting. For example, in one aspect, carboxyl-containing unsaturated monomers can be grafted to a polyolefin polymer, such as a polyethylene polymer. The carboxyl-containing unsaturated monomer, for instance, can be maleic acid anhydride.

For example, in one aspect, the surface tension reducing additive can be a polyethylene polymer functionalized with maleic acid anhydride. The polyethylene polymer can be the same as the high density polyethylene polymer that is combined with the surface tension reducing additive or can be a different polyethylene polymer. For example, the polyethylene polymer functionalized with the maleic acid anhydride can be a low density polyethylene polymer, such as a linear low density polyethylene polymer. Alternatively, the polyethylene polymer functionalized with the maleic acid anhydride can be a high density polyethylene polymer. The high density polyethylene polymer can have a molecular weight of greater than about 300,000 g/mol, such as greater than about 500,000 g/mol, such as greater than about 700,000 g/mol, and generally less than about 2,500,000 g/mol.

The polyethylene functionalized with the maleic acid anhydride can contain maleic acid anhydride in an amount generally greater than about 1.5% by weight, such as in an amount greater than about 1.8% by weight, such as in an amount greater than about 2% by weight, such as in an amount greater than about 2.5% by weight, such as in an amount greater than about 3% by weight, such as in an amount greater than about 3.5% by weight, such as in an amount greater than about 4% by weight, such as in an amount greater than about 4.5% by weight. The polyethylene functionalized with maleic acid anhydride generally can contain the maleic acid anhydride in an amount less than about 20% by weight, such as in an amount less than about 10% by weight, such as in an amount less than about 8% by weight, such as in an amount less than about 5% by weight. The polyethylene functionalized with maleic acid anhydride can be in the form of a powder or particles that are combined or compounded with the high density polyethylene particles.

In other embodiments, the surface tension reducing additive can be a fatty alcohol glycol ether such as an ethylene-vinyl alcohol copolymer. The surface tension reducing additive can also be an ethylene acrylic acid copolymer. The ethylene acrylic acid copolymer can generally have an acrylic acid content of greater than 5% by weight, such as greater than about 8% by weight, such as greater than about 10% by weight, and generally less than about 30% by weight, such as less than about 20% by weight, such as less than about 15% by weight, such as less than about 12% by weight.

The surface tension reducing additive can be any suitable acrylate polymer and/or a graft copolymer containing an olefin. The olefin polymer, such as polyethylene, can serve as a graft base and can be grafted to at least one vinyl polymer or one ether polymer.

Examples of surface tension reducing additives as described above include ethylene-acrylic acid copolymer, ethylene-maleic anhydride copolymers, ethylene-alkyl(meth)acrylate-maleic anhydride terpolymers, ethylene-alkyl(meth)acrylate-glycidyl(meth)acrylate terpolymers, ethylene-acrylic ester-methacrylic acid terpolymer, ethylene-acrylic ester-maleic anhydride terpolymer, ethylene-methacrylic acid-methacrylic acid alkaline metal salt (ionomer) terpolymers, and the like. In one embodiment, for instance, a surface tension reducing additive can include a random terpolymer of ethylene, methylacrylate, and glycidyl methacrylate. The terpolymer can have a glycidyl methacrylate content of from about 5% to about 20%, such as from about 6% to about 10%. The terpolymer may have a methylacrylate content of from about 20% to about 30%, such as about 24%.

The surface tension reducing additive may be a linear or branched, homopolymer or copolymer (e.g., random, graft, block, etc.) containing epoxy functionalization, e.g., terminal epoxy groups, skeletal oxirane units, and/or pendent epoxy groups. For instance, the surface tension reducing additive may be a copolymer including at least one monomer component that includes epoxy functionalization. The monomer units of the surface tension reducing additive may vary. For example, the surface tension reducing additive can include epoxy-functional methacrylic monomer units. As used herein, the term (meth)acrylic generally refers to both acrylic and methacrylic monomers, as well as salts and esters thereof, e.g., acrylate and methacrylate monomers. Epoxy-functional (meth)acrylic monomers that may be incorporated in the surface tension reducing additive may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate.

Examples of other monomers may include, for example, ester monomers, olefin monomers, amide monomers, etc. In one embodiment, the surface tension reducing additive can include at least one linear or branched α-olefin monomer, such as those having from 2 to 20 carbon atoms, or from 2 to 8 carbon atoms. Specific examples include ethylene; propylene; 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene.

In one embodiment, the surface tension reducing additive can be a terpolymer that includes epoxy functionalization. For instance, the surface tension reducing additive can include a methacrylic component that includes epoxy functionalization, an α-olefin component, and a methacrylic component that does not include epoxy functionalization. For example, the surface tension reducing additive may be poly(ethylene-co-methylacrylate-co-glycidyl methacrylate), which has the following structure:

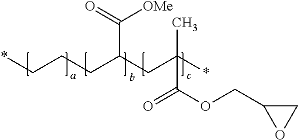

wherein, a, b, and c are 1 or greater.

In another embodiment the surface tension reducing additive can be a random copolymer of ethylene, ethyl acrylate and maleic anhydride having the following structure:

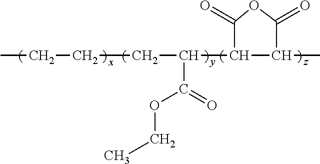

wherein x, y and z are 1 or greater.

The relative proportion of the various monomer components of a copolymeric surface tension reducing additive is not particularly limited. For instance, in one embodiment, the epoxy-functional methacrylic monomer components can form from about 1 wt. % to about 25 wt. %, or from about 2 wt. % to about 20 wt % of a copolymeric surface tension reducing additive. An α-olefin monomer can form from about 55 wt. % to about 95 wt. %, or from about 60 wt. % to about 90 wt. %, of a copolymeric surface tension reducing additive. When employed, other monomeric components (e.g., a non-epoxy functional methacrylic monomers) may constitute from about 5 wt. % to about 35 wt. %, or from about 8 wt. % to about 30 wt. %, of a copolymeric surface tension reducing additive.

The molecular weight of the above surface tension reducing additive can vary widely. For example, the surface tension reducing additive can have a number average molecular weight from about 7,500 to about 250,000 grams per mole, in some embodiments from about 15,000 to about 150,000 grams per mole, and in some embodiments, from about 20,000 to 100,000 grams per mole, with a polydispersity index typically ranging from 2.5 to 7.

In still another embodiment, the surface tension reducing additive can be a surfactant that can be melt processed with the high density polyethylene resin. For example, the surfactant can be a nonionic surfactant that is in the form of a solid at 23° C. In one aspect, for instance, the surface tension reducing additive can be an alkyl polyethylene glycol ether. The alkyl polyethylene glycol ether can be made from linear saturated C10 to C28, such as C16-C18, fatty alcohols. For example, the surfactant can be the reaction product of a fatty alcohol with ethylene oxide. The surfactant can contain a degree of ethoxylation of greater than about 8 mols, such as greater than about 10 mols, such as greater than about 20 mols, such as greater than about 30 mols, such as greater than about 40 mols, and generally less than about 100 mols, such as less than about 80 mols, such as less than about 60 mols.

In still another embodiment, the surface tension reducing additive can be a hydrophilic inorganic filler such as aluminum oxide or aluminum hydroxide. The aluminum oxide, for instance, can have a BET surface area of greater than about 85 m²/g, such as greater than about 90 m²/g, such is greater than about 100 m²/g, and generally less than about 500 m²/g, such as less than about 200 m²/g.

The hydrophilic inorganic filler can generally have a D50 particle size of less than about 30 microns, such as less than about 20 microns, such as less than about 15 microns, such as less than about 10 microns, and generally greater than about 0.1 microns, such as greater than about 0.5 microns, such as greater than about 1 micron, such as greater than about 3 microns, such as greater than about 5 microns.

In another aspect, the surface tension reducing additive can be a hydrophilic chemical agent that couples to the polyethylene polymer during melt processing or in-situ during formation of the polymer for increasing the wettability characteristics of the resulting article. The hydrophilic chemical agent, for instance, can chemically graft to the polyethylene polymer with functional chemical groups that increases the polarity of the polymer. Alternatively, the hydrophilic chemical agent can undergo a chemical reaction with other polar molecules on the polyethylene polymer for reducing surface tension.

In one aspect, for instance, the surface tension reducing additive can be an organic acid anhydride as described above that is combined with the polyethylene polymer during melt processing. For instance, the organic acid anhydride can comprise maleic acid anhydride. Alternatively, the surface tension reducing agent can be an acrylate or a methacrylate, such as glycidyl methacrylate. In still another alternative embodiment, the surface tension reducing agent can comprise an acrylic acid that contacts the polyethylene polymer in molten form and bonds with the polymer.

For example, in one embodiment, the surface tension reducing additive can comprise a polyethylene polymer that has been grafted with an acrylic acid. The amount of acrylic acid grafted to the polyethylene polymer can generally be greater than about 0.5% by weight, such as in an amount greater than about 1% by weight, such as in an amount greater than about 2% by weight, and generally in an amount less than about 25% by weight, such as in an amount less than about 15% by weight, such as in an amount less than about 10% by weight, such as in an amount less than about 8% by weight. The acrylic acid grafted polyethylene polymer can then be combined with an unmodified or ungrafted high density polyethylene polymer to form the porous polymer film. The resulting film can contain acrylic acid groups in an amount greater than about 0.01% by weight, such as greater than about 0.1% by weight, such as greater than about 0.5% by weight, such as in an amount greater than about 2% by weight, and generally in an amount less than about 15% by weight, such as in an amount less than about 10% by weight.

In one embodiment, once the acrylic acid is grafted to the polyethylene polymer, the acrylic acid can be saponified. Saponification can occur on the polymer resin or polymer particles or can occur after an article has been formed. In one aspect, the acrylic acid groups can be saponified by contacting the acrylic acid groups with a base, such as sodium hydroxide.

The grafted polyethylene polymer can be in the form of particles that are optionally blended with unmodified high density polyethylene polymer particles. The particles, for example, can have an average particle size (d50) by volume of less than about 400 microns, such as less than about 300 microns, such as less than about 200 microns, such as less than about 170 microns, such as less than about 150 microns, such as less than about 125 microns. The average particle size can be greater than about 20 microns, such as greater than about 30 microns, such as greater than about 40 microns, such as greater than about 50 microns.

In forming porous polymer films in accordance with the present disclosure, the high density polyethylene particles are combined with a plasticizer and then gel extruded.

The plasticizer, for instance, may comprise a hydrocarbon oil, an alcohol, an ether, an ester such as a diester, or mixtures thereof. For instance, suitable plasticizers include mineral oil, a paraffinic oil, decaline, and the like. Other plasticizers include xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, and the like. In one embodiment, the plasticizer may comprise a halogenated hydrocarbon, such as monochlorobenzene. Cycloalkanes and cycloalkenes may also be used, such as camphene, methane, dipentene, methylcyclopentandiene, tricyclodecane, 1,2,4,5-tetramethyl-1,4-cyclohexadiene, and the like. The plasticizer may comprise mixtures and combinations of any of the above as well.

The plasticizer is generally present in the composition used to form the polymer articles in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight. In fact, the plasticizer can be present in an amount up to about 99.5% by weight.

The high density polyethylene particles blend with the plasticizer to form a homogeneous gel-like material.

In order to form polymer articles in accordance with the present disclosure, the high density polyethylene particles are combined with the plasticizer and extruded through a die of a desired shape. In one embodiment, the composition can be heated within the extruder. For example, the plasticizer can be combined with the particle mixture and fed into an extruder. In accordance with the present disclosure, the plasticizer and particle mixture form a homogeneous gel-like material prior to leaving the extruder for forming polymer articles with little to no impurities.

In one embodiment, elongated articles are formed during the gel spinning or extruding process. The polymer article, for instance, may be in the form of a fiber or a film, such as a membrane.

During the process, at least a portion of the plasticizer is removed from the final product. The plasticizer removal process may occur due to evaporation when a relatively volatile plasticizer is used. Otherwise, an extraction liquid can be used to remove the plasticizer. The extraction liquid may comprise, for instance, a hydrocarbon solvent. One example of the extraction liquid, for instance, is dichloromethane. Other extraction liquids include acetone, chloroform, an alkane, hexene, heptene, an alcohol, or mixtures thereof.

If desired, the resulting polymer article can be stretched at an elevated temperature below the melting point of the polyethylene polymer to increase strength and modulus. Suitable temperatures for stretching are in the range of from about ambient temperature to about 155° C. The draw ratios can generally be greater than about 4, such as greater than about 6, such as greater than about 8, such as greater than about 10, such as greater than about 15, such as greater than about 20, such as greater than about 25, such as greater than about 30. In certain embodiments, the draw ratio can be greater than about 50, such as greater than about 100, such as greater than about 110, such as greater than about 120, such as greater than about 130, such as greater than about 140, such as greater than about 150. Draw ratios are generally less than about 1,000, such as less than about 800, such as less than about 600, such as less than about 400. In one embodiment, lower draw ratios are used such as from about 4 to about 10. The polymer article can be uniaxially stretched or biaxially stretched.

Polymer articles made in accordance with the present disclosure have numerous uses and applications. For example, in one embodiment, the process is used to produce a membrane. The membrane or film can be used, for instance, as a battery separator. Alternatively, the membrane can be used as a microfilter. When producing fibers, the fibers can be used to produce nonwoven fabrics, ropes, nets, and the like. In one embodiment, the fibers can be used as a filler material in ballistic apparel.

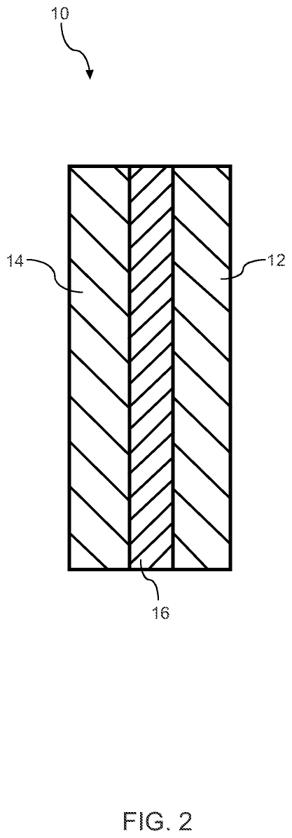

Referring to FIG. 2, one embodiment of a lithium ion battery 10 made in accordance with the present disclosure is shown. The battery 10 includes an anode 12 and a cathode 14. The anode 12, for instance, can be made from a lithium metal. The cathode 14, on the other hand, can be made from sulfur or from an intercalated lithium metal oxide. In accordance with the present disclosure, the battery 10 further includes a porous membrane 16 or separator that is positioned between the anode 12 and the cathode 14. The porous membrane 16 minimizes electrical shorts between the two electrodes while allowing the passage of ions, such as lithium ions. As shown in FIG. 2, in one embodiment, the porous membrane 16 is a single layer polymer membrane and does not include a multilayer structure. In one aspect, the single layer polymer membrane may also include a coating. The coating can be an inorganic coating made from, for instance, aluminum oxide or a titanium oxide. Alternatively, the single layer polymer membrane may also include a polymeric coating. The coating can provide increased thermal resistance.

The polymer composition and polymer articles made in accordance with the present disclosure may contain various other additives, such as heat stabilizers, light stabilizers, UV absorbers, acid scavengers, flame retardants, lubricants, colorants, and the like.

In one embodiment, a heat stabilizer may be present in the composition. The heat stabilizer may include, but is not limited to, phosphites, aminic antioxidants, phenolic antioxidants, or any combination thereof.

In one embodiment, an antioxidant may be present in the composition. The antioxidant may include, but is not limited to, secondary aromatic amines, benzofuranones, sterically hindered phenols, or any combination thereof.

In one embodiment, a light stabilizer may be present in the composition. The light stabilizer may include, but is not limited to, 2-(2′-hydroxyphenyl)-benzotriazoles, 2-hydroxy-4-alkoxybenzophenones, nickel containing light stabilizers, 3,5-di-tert-butyl-4-hydroxbenzoates, sterically hindered amines (HALS), or any combination thereof.

In one embodiment, a UV absorber may be present in the composition in lieu of or in addition to the light stabilizer. The UV absorber may include, but is not limited to, a benzotriazole, a benzoate, or a combination thereof, or any combination thereof.

In one embodiment, a halogenated flame retardant may be present in the composition. The halogenated flame retardant may include, but is not limited to, tetrabromobisphenol A (TBBA), tetrabromophthalic acid anhydride, dedecachloropentacyclooctadecadiene (dechlorane), hexabromocyclodedecane, chlorinated paraffins, or any combination thereof.

In one embodiment, a non-halogenated flame retardant may be present in the composition. The non-halogenated flame retardant may include, but is not limited to, resorcinol diphosphoric acid tetraphenyl ester (RDP), ammonium polyphosphate (APP), phosphine acid derivatives, triaryl phosphates, trichloropropylphosphate (TCPP), magnesium hydroxide, aluminum trihydroxide, antimony trioxide.

In one embodiment, a lubricant may be present in the composition. The lubricant may include, but is not limited to, silicone oil, waxes, molybdenum disulfide, or any combination thereof.

In one embodiment, a colorant may be present in the composition. The colorant may include, but is not limited to, inorganic and organic based color pigments.

In one aspect, an acid scavenger may be present in the polymer composition. The acid scavenger, for instance, may comprise an alkali metal salt or an alkaline earth metal salt. The salt can comprise a salt of a fatty acid, such as a stearate. Other acid scavengers include carbonates, oxides, or hydroxides. Particular acid scavengers that may be incorporated into the polymer composition include a metal stearate, such as calcium stearate. Still other acid scavengers include zinc oxide, calcium carbonate, magnesium oxide, and mixtures thereof.

These additives may be used singly or in any combination thereof. In general, each additive may be present in an amount of at least about 0.05 wt. %, such as at last about 0.1 wt. %, such as at least about 0.25 wt. %, such as at least about 0.5 wt. %, such as at least about 1 wt. % and generally less than about 20 wt. %, such as less than about 10 wt. %, such as less than about 5 wt. %, such as less than about 4 wt. %, such as less than about 2 wt. %. The sum of the wt. % of all of the components, including any additives if present, utilized in the polymer composition will be 100 wt. %.

After porous polymer films are formed in accordance with the present disclosure and optionally subjected to a stretching process, the films are exposed to an oxygen plasma process as described above. In one embodiment, only one side of the film is subjected to the oxygen plasma treatment. In an alternative embodiment, each side of the film can be subjected to the oxygen plasma treatment.

The present disclosure may be better understood with reference to the following example. The following example is given below by way of illustration and not by way of limitation. The following experiments were conducted in order to show some of the benefits and advantages of the present invention.

### Example No. 1

Porous polymer films were produced and subjected to an oxygen plasma treatment in accordance with the present disclosure. The films were tested for wicking distance and wettability and compared with films that were not subjected to the oxygen plasma treatment.

A single high density polyethylene polymer was used to produce the films. The polyethylene polymer had a molecular weight of 600,000 g/mol and an average particle size (d50) of 115 microns. The polyethylene polymer had a density of 950 kg/m³ and had a melt flow rate of 1.1 g/10 minutes.

The polyethylene polymer was combined with a plasticizer and formed into a porous polymer film via gel extrusion, biaxial stretching, and solvent extraction as are conventional. The gel composition that was extruded had a solid content of 30 wt. % resin in paraffin oil. Gel extrusion was carried out at a temperature of from 190° C. to 240° C. and at a screw speed of 200 rpm. After extrusion, the resulting porous polymer film was solidified on a chill roller set to 40° C. Stretching was performed in a 7×7 ratio (MD/TD) at a temperature of 120° C. Extraction of the stretched film was performed in acetone. The porous polymer films were annealed at 130° C. for 10 minutes.

Samples of the porous polymer film as described above were then subjected to an oxygen plasma process in accordance with the present disclosure. One film was produced that was subjected to the oxygen plasma treatment on one side. Another sample was produced in which both sides of the film were subjected to the oxygen plasma treatment.

The films were then subjected to the soaking test as described above with propylene carbonate. A film that was not subjected to the plasma treatment was also tested. The following results were obtained:

| | | | Comparison |
|---|---|---|---|
| | | Wicking Distance | (increase from |
| Sample No. | Plasma Treatment | (mm) | control) |
| 1 | Untreated | 5 | — |
| 2 | One side treated | 10.5 | 110% |
| 3 | Two sides treated | 17 | 240% |

As shown above, subjecting the porous polymer film to an oxygen plasma treatment increased the wicking distance by greater than 100% and displayed a wicking distance of greater than 10 mm (and generally less than 30 mm). When both sides of the film were treated, the wicking distance increased by greater than 225%. In addition, there was no noticeable deterioration of mechanical properties. The films were found to have mechanical properties within the ranges described above.

Sample Nos. 1 and 2 above were also tested for contact angle against water. The plasma treated sample was subjected to the plasma treatment for different times to determine the effect. In particular, samples were produced in which the plasma treatment lasted 5 seconds, 10 seconds, 30 seconds, or 60 seconds. The following results were obtained:

| | Plasma Treatment Time | |
|---|---|---|
| Sample No. | (seconds) | Contact Angle |
| 1 | 0 | 118° |
| 2 | 5 | 59° |
| 2 | 10 | 59° |
| 2 | 30 | 59° |
| 2 | 60 | 58° |

As shown above, the contact angle of the plasma treated samples decreased by greater than 50% in relation to the untreated sample. As also shown above, exposure time did not have any significant impact on contact angle. Exposure time, however, can affect the physical properties of the film and can cause the film to shrink. Thus, in one aspect, the present disclosure is directed to producing plasma oxidized films that have had exposure times of less than about 30 seconds, such as less than about 20 seconds, such as less than about 10 seconds, such as even less than about 5 seconds.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims

1. An ion separator for dividing an anode from a cathode comprising:
a porous polymer film, the porous polymer film comprising a high density polyethylene polymer, the polyethylene polymer having a number average molecular weight of greater than about 300,000 g/mol, the porous polymer film having a first surface and a second and opposite surface, at least the first surface of the porous polymer film having been plasma oxidized to form polar groups attached to the high density polyethylene polymer that increase the polarity of the surface of the porous polymer film, and wherein the plasma oxidized polar groups are present in an amount sufficient to increase a wicking distance of the porous polymer film when subjected to a soaking test and tested against propylene carbonate of greater than about 50% in comparison to an identical porous polymer film that has not been plasma oxidized.

2. An ion separator as defined in claim 1, wherein the porous polymer film displays a contact angle when measured against water of less than about 90°.

3. An ion separator as defined in claim 1, wherein the plasma oxidized polar groups are present on the porous polymer film in an amount sufficient to increase a wicking distance when subjected to a soaking test and tested against propylene carbonate of greater than about 70% in comparison to an identical porous polymer film that has not been plasma oxidized.

4. An ion separator as defined in claim 1, wherein the plasma oxidized polar groups are present on the porous polymer film in an amount sufficient to reduce a contact angle of the porous polymer film when measured against water of greater than about 15%, such as greater than about 25%, such as greater than about 35%, such as greater than about 45% in comparison to an identical porous polymer film that has not been plasma oxidized.

5. An ion separator as defined in claim 1, wherein the porous polymer film has been plasma oxidized without causing the film to shrink by more than about 5%.

6. An ion separator as defined in claim 1, wherein the porous polymer film has been plasma oxidized without causing the film to decrease in tensile strength in one direction by more than about 10%.

7. An ion separator as defined in claim 1, wherein the high density polyethylene is a Ziegler-Natta catalyzed high molecular weight polyethylene.

8. An ion separator as defined in claim 1, wherein the porous polymer film has a thickness of from about 4 microns to about 25 microns and has a porosity of from about 20% to about 50%.

9. An ion separator as defined in claim 1, wherein the high density polyethylene polymer is present in the porous film in an amount of from about 60% by weight to about 99% by weight.

10. An ion separator as defined in claim 1, wherein the high density polyethylene has a molecular weight of greater than about 400,000 g/mol and less than about 12,000,000 g/mol.

11. An ion separator as defined in claim 1, wherein the high density polyethylene has a molecular weight of greater than about 550,000 g/mol and less than about 1,200,000 g/mol.

12. An ion separator as defined in claim 1, wherein the ion separator is a single layer polymer porous film that may optionally include a coating.

13. An ion separator as defined in claim 12, wherein the single layer polymer porous film includes a coating, the coating comprising an inorganic coating or a polymer coating.

14. An ion separator as defined in claim 1, wherein the porous polymer film is polypropylene-free.

15. An ion separator as defined in claim 1, wherein the porous polymer film has a porosity of from about 35% to about 38% and has a puncture strength greater than 1000 mN/micron and a pin strength of greater than about 200 gf/g/cm2

16. An ion separator as defined in claim 1, wherein the porous polymer film has a porosity of from about 38% to about 50% and has a puncture strength greater than 300 mN/micron and a pin strength of greater than about 70 gf/g/cm2.

17. An ion separator as defined in claim 1, wherein the porous polymer film has been biaxially stretched.

18. An ion separator as defined in claim 1, wherein the porous polymer film has a tensile strength of greater than about 100 MPa.

19. An ion separator as defined in claim 1, wherein the second surface of the porous polymer film has also been plasma oxidized to form polar groups attached to the high density polyethylene polymer.

20. A process for producing the ion separator as defined in claim 1 wherein the first surface of the porous film is subjected to an oxidized plasma for less than about 30 seconds.

21. A process for producing the ion separator as defined in claim 1 wherein the first surface of the porous film is subjected to an oxygen plasma with microwave discharge.

22. A process for producing the ion separator as defined in claim 1 wherein the first surface of the porous film is subjected to an oxygen plasma at a temperature of less than about 60° C. and at a pressure of less than about 10,000 pa.
